(19) United States
(12) Patent Application Publication
(10) Pub. No.: US 2026/0141245 A1
(43) Pub. Date: May 21, 2026

(54) PROMPT TUNING USING DIFF FORMAT OUTPUTS

(71) Applicant: Microsoft Technology Licensing, LLC, Redmond, WA (US)

(72) Inventors: Royi RONEN, London (GB); Vladyslav KOLESNYK, London (GB); Phuong Hoa GIANG, London (GB)

(73) Assignee: Microsoft Technology Licensing, LLC, Redmond, WA (US)

(21) Appl. No.: 18/951,929

(22) Filed: Nov. 19, 2024

(51) Int. Cl. G06N 3/0895

(52) U.S. Cl. CPC G06N 3/0895

(57) ABSTRACT

Implementations using diff formats for multi-objective prompt tuning are provided. One implementation includes a computing system comprising processing circuitry and memory storing instructions that, during execution, causes the processing circuitry to receive an initial prompt, generate a plurality of prompt variants based on the initial prompt, wherein each of the prompt variants is in a diff format that describes changes from the initial prompt, derive a plurality of prompt candidates based on the initial prompt and the plurality of prompt variants, wherein each of the prompt candidates is derived by applying the changes described in a respective prompt variant to the initial prompt, evaluate the plurality of prompt candidates to determine a quality of each prompt candidate based on at least one target metric, and select and output a prompt candidate from the plurality of prompt candidates based on the determined quality of the prompt candidates.

### BACKGROUND

Language models are machine learning models implemented using deep learning techniques to perform a variety of natural language processing tasks, including language generation, language recognition, translation, word prediction, etc. Language models can be classified by their size and/or the number of parameters implemented. Large language models have been implemented with parameters ranging from a few hundred million to over a trillion.

Despite the vast amount of training data that some large language models go through, practical applications of pre-trained large language models often include further tuning, such as through fine-tuning with additional data for a specific task or through prompt engineering. Prompt engineering is a front-end approach that guides and modulates the pre-trained model's behavior by crafting, through human involvement, more nuanced input prompts.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Implementations using diff formats for multi-objective prompt tuning are provided. One implementation includes a computing system comprising processing circuitry and memory storing instructions that, during execution, causes the processing circuitry to receive an initial prompt, generate a plurality of prompt variants based on the initial prompt, wherein each of the prompt variants is in a diff format that describes changes from the initial prompt, derive a plurality of prompt candidates based on the initial prompt and the plurality of prompt variants, wherein each of the prompt candidates is derived by applying the changes described in a respective prompt variant to the initial prompt, evaluate the plurality of prompt candidates to determine a quality of each prompt candidate based on at least one target metric, and select and output a prompt candidate from the plurality of prompt candidates based on the determined quality of the prompt candidates.

### BRIEF DESCRIPTION OF THE DRAWINGS

FIG. 1 shows a schematic view of an example computing system for prompt tuning.

FIG. 2 shows a data flow diagram of an example prompt tuning process, which can be implemented using the example computing system of FIG. 1.

FIG. 3 shows a data flow diagram of an example prompt tuning process utilizing a large language model, which can be implemented using the example computing system of FIG. 1.

FIGS. 4A and 4B show generation of a text file in an example diff format, which can be implemented using the example computing system of FIG. 1.

FIG. 5 shows a process flow diagram of an example prompt tuning method, which can be implemented using the example computing system of FIG. 1.

FIG. 6 shows a schematic view of an example computing environment that can enact one or more of the methods and processes described herein.

### DETAILED DESCRIPTION

Large language models (LLMs) have been shown to be powerful tools for performing various natural language processing (NLP) tasks, such as language generation, language recognition, translation, word prediction, etc. These LLMs use prompt inputs to follow human instructions to perform such tasks. Prompts and their design have a significant impact on the quality of the output generated by the LLM. However, manually changing these prompts, such as through prompt engineering techniques, can be prohibitively time-consuming. Writing prompts in natural language remains a trial-and-error process requiring significant human effort and expertise. As such, there is a desire for automatic or semiautomatic procedures in prompt development that reduce human involvement and expertise requirements while improving and providing reliable task performance.

One technique for automating prompt development includes prompt tuning. Prompt tuning can be implemented with automated processes that iteratively refine an initial prompt through tuning of different parameters and/or aspects of the prompt. This enables the output of a pre-trained LLM to be guided without retraining of the weights and parameters of the LLM. Generally, prompt tuning involves taking an initial prompt and generating multiple prompt candidates with different variations of different aspects of the initial prompt. The prompt candidates are tested for performance accuracy, and one is selected for output or as the basis prompt for the next iteration. Additionally or alternatively, the performance of the other candidates can be used to guide the generation of the next round of prompt candidates. Although prompt-tuning provides an automated prompt development, such techniques can be computationally intensive in cases with large prompts and/or where a large number of prompt candidates are generated at each iteration.

In view of the observations above, techniques for prompt tuning using diff space outputs are provided. Generally, prompt tuning involves the generation of prompt candidates with slight variations in one or more aspects of an initial prompt. In cases of large (long) prompts, the generation of prompt candidates can be computationally inefficient. For example, prompting an LLM to generate and output prompt candidates based on a large prompt can result in prompt candidates that are largely similar in content but with small variations. Although the variations are of importance, the inference time will be largely focused on the generation of similar content. To address these inefficiencies, the techniques described herein contemplate operating in diff format space in one or more processes of the prompt tuning pipeline. For example, configuring an LLM to operate in diff format space for the generation of prompt candidates can result in faster inference speed compared to outputting full-length prompts. The increase in generation speed provides several technical advantages. For example, the increased prompt candidate generation speed can result in an overall faster prompt tuning speed that enables better prompt development through more complex optimizations. Generally, optimization of a prompt in more than one target objective has been prohibitively expensive in time and computational resources. With less resources devoted to the candidate generation phase, prompts can be optimally tuned across multiple objective targets.

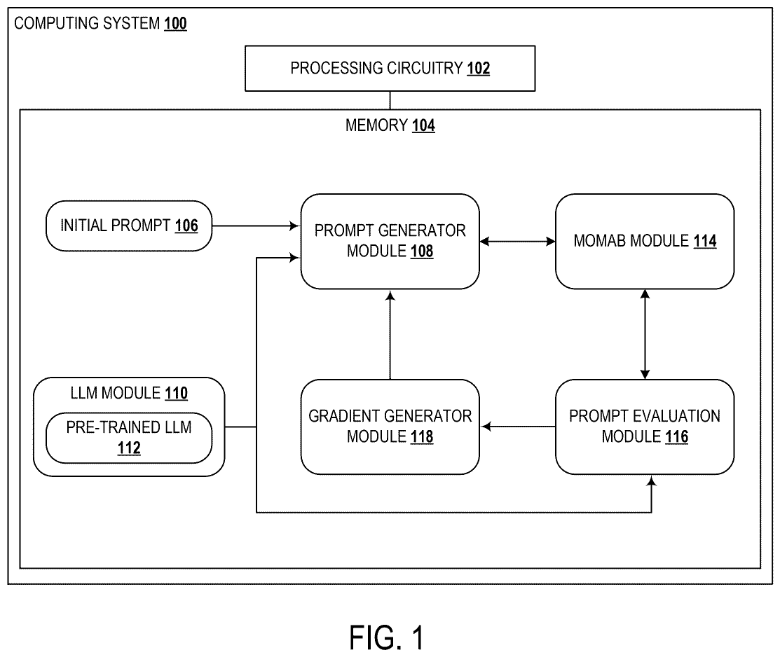

Turning now to the figures, prompt tuning using diff format outputs are illustrated and described in further detail. FIG. 1 shows a schematic view of an example computing system 100 for prompt tuning. The example computing system 100 includes processing circuitry 102 and memory 104 storing instructions that, during execution, causes the processing circuitry 102 to perform prompt tuning and/or other processes described herein. The example computing system 100 can be implemented with various types of computing devices, including but not limited to personal computers, servers, and mobile devices. The example computing system 100 can also include non-depicted components for providing various functionalities.

The example computing system 100 can be implemented to perform a prompt tuning process through use of various modules responsible for data manipulation at various stages of the process. Although FIG. 1 depicts a system for prompt tuning, such systems can be configured for any text-edit or text correction application. For example, the system can be implemented for rewriting emails. The prompt tuning process starts with receiving an initial prompt 106. The initial prompt 106 can be of various formats. Generally, the initial prompt 106 includes a task description. In some implementations, the initial prompt 106 further includes one or more canonical examples of the task.

The initial prompt 106 is provided to a prompt generator module 108 capable of generating a plurality of prompt variants from the initial prompt 106. The prompt generator module 108 can be implemented in various ways. In the depicted example, the prompt generator module 108 utilizes a large language model module 110 for generating the prompt variants. For the purposes of this disclosure, language models, small language models, and large language models can be used interchangeably as the concepts described herein can be implemented with language models of any size. The LLM module 110 includes one or more LLMs, including at least one pre-trained LLM 112 capable of outputting the prompt variants. In some implementations, the pre-trained LLM 112 takes the initial prompt 106 as input along with a prompt containing instructions tasking the LLM 112 to generate and output multiple prompt variants based on the initial prompt 106.

In some implementations, the pre-trained LLM 112 is prompted to generate the prompt variants in a diff format. A diff format refers to a defined way of storing data representing changes between the contents of two text documents. In the case of prompt tuning, the prompt variant describes changes to the initial prompt 106 such that a full-length prompt variant can be derived by applying the changes to the initial prompt 106. Any type of diff format can be utilized. In some implementations, the prompt variants are in a unified diff format (unidiff).

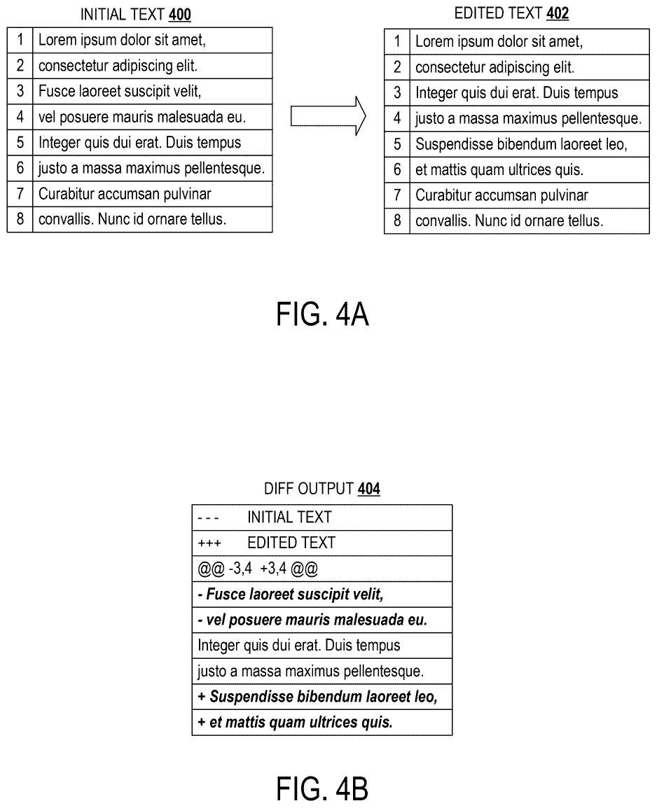

As LLMs are used, hallucinations can occur where the output contains one or more errors. For example, the LLM can output a prompt variant with a formatting error (or any other type of error) that needs to be corrected. As such, in some implementations, the prompt generator module 108 includes an error-correction layer. The error-correction layer can be implemented in various ways. For example, the error-correction layer can be implemented to provide the prompt variant output back into the LLM with a prompt to correct for errors. The prompt may be generalized or specific (e.g., instructions to correct for hallucinations, instructions to correct for a common formatting error, etc.). An example of a diff format with defined formatting rules is described in the sections below with respect to FIGS. 4A and 4B and their accompanying descriptions.

Referring back to FIG. 1, the example computing system 100 further includes a multi-objective multi-arm bandit (MOMAB) module 114. The MOMAB module 114 takes the plurality of prompt variants as an input and selects one of them to output. In some cases, the selected prompt variant is output/returned to the prompt generator module 108 for iterative refinement. The output prompt variant can be selected based on various criteria. In the depicted example, the MOMAB module 114 selects the prompt variant in an optimization process that selects the best performing prompt variant in accordance with multiple objective target metrics using a multi-arm bandit algorithm. Although FIG. 1 depicts a MOMAB module for multi-objective optimization, the prompt tuning process as described herein can be performed to optimize a single objective target metric.

The MOMAB process can be implemented in various ways to select the prompt variant. In the depicted example, the MOMAB module 114 passes the plurality of prompt variants to a prompt evaluation module 116 capable of evaluating the prompt variants and returning evaluation results to the MOMAB module 114, which can be used to select the prompt variant in accordance with the MOMAB algorithm. The prompt evaluation module 116 can be implemented in various ways. In the depicted example, the prompt evaluation module 116 utilizes the LLM module 110 to evaluate the prompt variants to provide the evaluation results. The evaluation results can be of various formats capable of being processed by the MOMAB module 114 to select the best prompt variant based on one or more target metrics. Any type of target metric can be used. Examples of such include but are not limited to prompt length, prompt relevancy, LLM-based metrics that measure readability, LLM-based metrics that count the number of key points, etc. In some implementations, the evaluation results can be provided in the form of numerical values that indicate the quality of the prompt variants. In some implementations, the LLM module 110 evaluates each prompt variant against multiple target metrics.

In some implementations, the LLM module 110 evaluates the prompt variants using one or more pre-trained LLMs 112. The pre-trained LLM 112 utilized can be the same or a different LLM from the one utilized for the generation of the prompt variants. For example, in some implementations, the LLM module 110 includes a first LLM trained for the generation of prompt variants and a second LLM trained to evaluate the prompt variants. In the depicted example, the pre-trained LLM 112 is a frozen LLM, wherein its weights and parameters are not changed throughout the prompt tuning process. Instead of modifying the LLM 112 for a specific task, tuned prompt information can be stored and called upon when the associated task needs to be performed.

In cases where the prompt variants are in a diff format, the prompt variants can be converted to full length prompts (prompt candidates) before they are fed into the LLM 112 for evaluation. For the purposes of this disclosure, a prompt candidate refers to a full-length modified prompt that can be constructed using a diff format prompt variant and the input prompt from which the diff format prompt variant is generated. The prompt candidates can be generated in various ways. For example, post-processing logic can be applied to generate the prompt candidates using diff format files and the initial prompt 106.

In addition to evaluating prompt variants, the prompt evaluation module 116 can also provide information relating to poorly performing or low quality prompt variants. Such information can be used to guide the generation of the next iteration of prompt variants to address the reasons why the prompt variants are of low quality or performed poorly. In the depicted example, the prompt evaluation module 116 provides information describing the reasons for the evaluation results of the prompt variants to a gradient generator module 118. The gradient generator module 118 can be implemented in various ways. In some implementations, the gradient generator module 118 utilizes the information describing the reasons for the evaluation results to generate natural language gradients that can help guide the LLM 112 utilized by the prompt generator module 108 in generating the next batch of prompt variants.

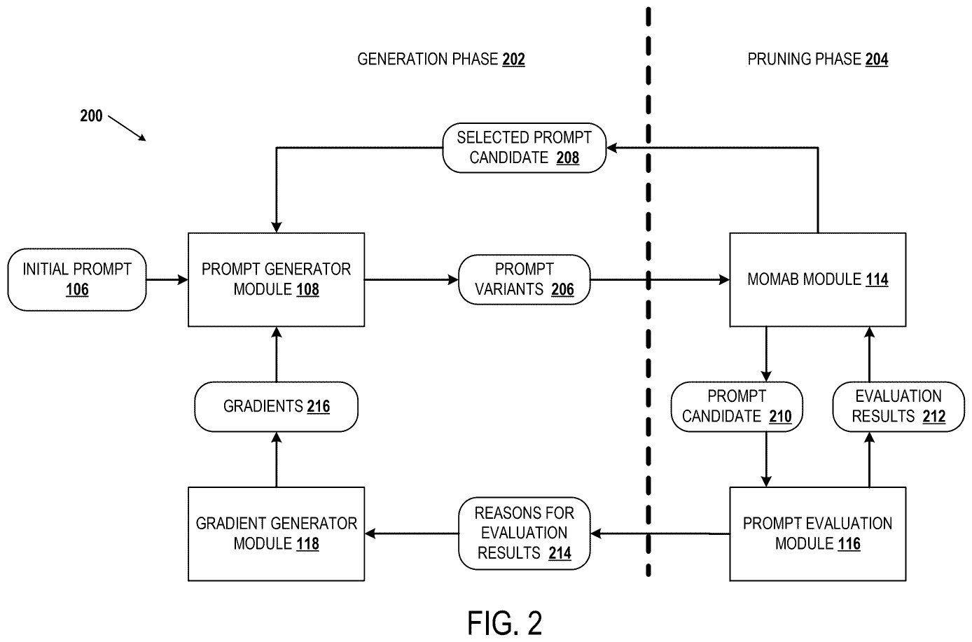

FIG. 2 shows a data flow diagram of an example prompt tuning process 200. Logically, the prompt tuning process 200 can be divided into a generation phase 202 and a pruning phase 204. In the generation phase 202, new prompt variants 206 are generated from a current prompt. In the pruning phase 204, prompt variants 206 are explored (e.g., through beam search) and selected based on rewards estimated using a gradient descent process.

Starting with the generation phase 202, the process 200 includes feeding an initial prompt 106 into a prompt generator module 108. The initial prompt 106 can be structured in various ways. In some implementations, the initial prompt 106 includes a task description and/or one or more canonical examples of the task. Furthermore, the prompt tuning process 200 can be applied for various text editing applications other than prompt tuning. For example, the initial prompt 106 can be replaced with an email or any other writing that is to be edited/corrected.

The prompt generator module 108 utilizes the initial prompt 106 to generate a plurality of prompt variants 206. The prompt variants 206 can be generated in various ways. In some implementations, the prompt generator module 108 utilizes a pre-trained LLM to generate the plurality of prompt variants 206, each of which is a diff format file describing changes between the initial prompt 106 and a modified prompt. Any type of diff format can be utilized. In some implementations, the prompt variants 206 are in a unidiff format. Various types of LLMs can be utilized. For example, the LLM can be pre-trained for the specific task of generating prompt variants in a predefined diff format. Different sizes of LLMs can be implemented. With the pre-trained LLM, the initial prompt 106 can be used in combination with a prompt instructing the LLM to generate variants of the initial prompt 106 in a specified diff format. In some implementations, the prompt generator module 108 includes an error-correction process that corrects for hallucinations in the LLM output. For example, the LLM may output prompt variants 206 that are not in the correct diff format. As such, the error-correction step can be applied to ensure that the prompt variants 206 comply with the specified diff format. The error-correction can be performed in various ways, including feeding the output back into the LLM, or another LLM, with a prompt describing the error-correction task.

Generally, prompting an LLM to output many different variants of a large prompt can be costly in time and resources. Outputting a large prompt involves a large number of output tokens, which can be a bottleneck for inference speed. To reduce the number of output tokens generated by the LLM, the example prompt tuning process 200 described herein takes advantage of the similarities among prompt variants, which are typically designed to have small variations/modifications compared to the original prompt. As such, the contents shared between the initial prompt and its variant can have a large overlap. Generating this shared content for each variant can be unnecessarily taxing. With the use of diff format outputs, the shared content between the number of initial text and its modified variant does not need to be recorded, allowing for the number of LLM output tokens to be drastically reduced. Less output tokens during inference allows the process to optimize for larger prompts (or text) faster. As can readily be appreciated, different amounts of efficiency gains can be achieved in the tuning process depending on the initial prompt length and the extent of modifications made in the resulting variants.

During the pruning phase 204 of the prompt tuning process 200, a prompt candidate 208 is selected from the prompt variants 206. The prompt candidate 208 can be selected in various ways. In the depicted example, a MOMAB module 114 is used to select the prompt candidate 208 from the prompt variants 206 for output or use in the next iteration of prompt tuning. The MOMAB module 114 attempts to select a prompt candidate based on optimization of multiple target metrics. Any type of target metric can be used. Examples of such include but are not limited to length of generated content, relevancy of generated content, LLM-based metrics that measure readability, LLM-based metrics that count the number of key points, etc. In traditional prompt tuning, multi-objective optimization involves a difficult challenge as evaluation loops for multiple metrics are much longer compared to a single metric. However, due to the increase efficiency in tuning speed relating to the use of diff format outputs, the prompt tuning process 200 can be enabled to practically optimize for multiple different object target metrics in its iterative prompt refinement process. For example, the MOMAB algorithm can attempt to maximize readability and relevancy of a prompt while minimizing its length. In some implementations, the selection of the prompt candidates is based on a single target metric.

In the example prompt tuning process 200, the target metrics utilized by the MOMAB algorithm are provided by a prompt evaluation module 116 capable of evaluating prompt variants 206. Before evaluation, the prompt variants 206 can be converted into full length prompt candidates 210. For example, post-processing logic can be applied to infer the changes necessary to generate the prompt candidates 210 from the prompt variants 206. The prompt evaluation module 116 then evaluates at least one prompt candidate 210 received from the MOMAB module 114 and returns at least one evaluation result 212. In some implementations, the prompt evaluation module 116 evaluates each of the prompt candidates derived from the prompt variants 206 and returns a plurality of corresponding respective evaluation results 212. In other implementations, only a subset of the prompt candidates 210 is evaluated for a more efficient process. For example, the evaluation process can be streamlined such that evaluation runs are sampled to determine and remove prompt-arms that will likely perform poorly. The pruning step can be implemented in various ways. In some implementations, prompt variants (or prompt candidates) failing to satisfy one or more predetermined criteria are removed from the full evaluation process. Example criteria can include but are not limited to diff formatting requirements, correct prompt structure, correct prompt length, etc. For example, instead of evaluating each prompt variant fully, prompt variants (or prompt candidates) that break the expected diff format (or prompt format) can be removed from further evaluation. Evaluation of prompt candidates 210 by the prompt evaluation module 116 can be performed in various ways. In some implementations, the prompt candidates 210 are evaluated by a pre-trained LLM. The LLM can be the same LLM that generated the prompt variants 206 or a different one. For example, an LLM trained to generate prompt variants can be utilized by the prompt generator module 108, and a different LLM trained to evaluate the prompt can be utilized by the prompt evaluation module 116.

Automated processes for evaluating the prompt candidates 210 can be implemented using the pre-trained LLM and provided ground-truth data that describes the desired LLM output associated with the prompt being tuned. Similarity to the ground-truth data can result in better evaluation results 212. Prompt candidates 210 resulting in outputs that deviate from the desired output (the provided ground-truth data) can result in corresponding levels of error loss. Higher levels of error loss can indicate that the prompt candidate 210 should be adjusted in a different semantic direction, which can be applied in the next iteration. In some implementations, a gradient descent process can be applied to guide the generation of new prompt variants. The process utilizes data describing the reasons 214 for the evaluation results 212 of the current prompt candidates 210. The reasons 214 for the evaluation results 212 can include text-based feedback based on one or more of the objective target metrics. The reasons 214 for the evaluation results 212 can be provided in various ways. In some implementations, they are provided via user feedback. In other implementations, the errors of the LLM output are fed into a prompt that instructs an LLM to describe the problems that could have led to the errors.

A gradient generator module 118 receives the reasons 214 for the evaluation results 212 and generates corresponding gradients 216. The gradients 216 can be implemented as natural language gradients that can be used by the prompt generator module 108 to generate new prompt variants. For example, the gradients 216 can be provided to a prompt that instructs the LLM to edit the earlier selected prompt candidate 208 to address the issues that led to errors in the previous prompt variants. As described, the prompt tuning process 200 is capable of performing a recursive feedback loop that iteratively refines the initial prompt 106.

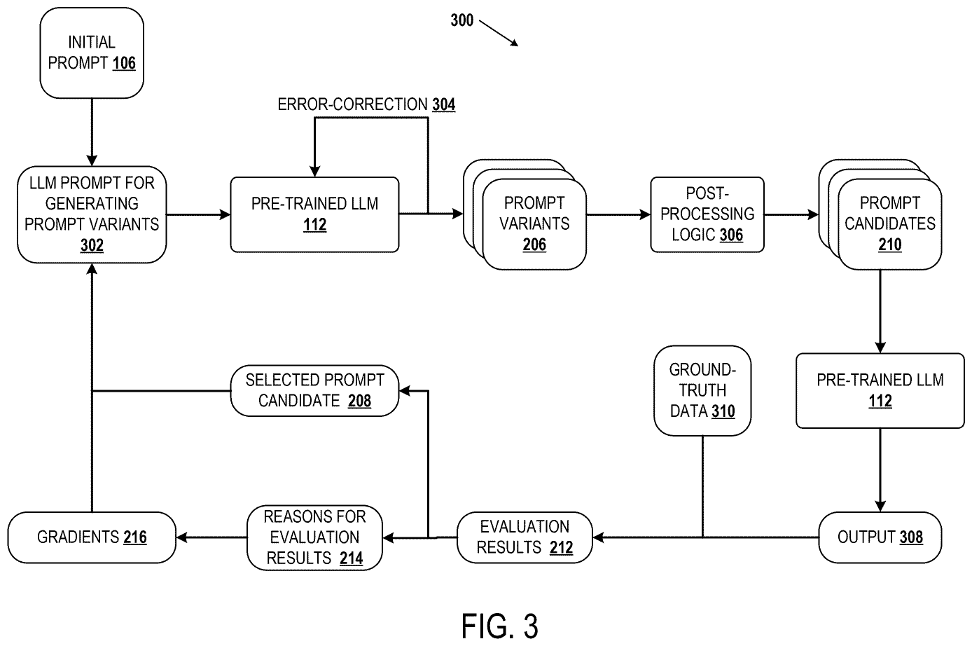

FIG. 2 depicts an example prompt tuning process 200 utilizing conceptual modules for performing various tasks. The modules can be implemented in various ways. For example, prompt generation and evaluation can be performed using one or more pre-trained LLMs. FIG. 3 shows a data flow diagram of an example prompt tuning process 300 utilizing one or more pre-trained LLMs 112. The process 300 starts with an initial prompt 106 that is to be tuned. The initial prompt 106 can be structured in various ways. In some implementations, the initial prompt 106 includes a task description and/or one or more canonical examples of the task. In some implementations, the prompt tuning process 300 is performed for a general text editing application, and the initial prompt 106 can be general text.

Together with an LLM prompt 302 for generating prompt variants, the initial prompt 106 is fed to a pre-trained LLM 112 to generate a plurality of prompt variants 206 in a diff format, which can be described in the LLM prompt 302. Any type of diff format can be utilized, including the example diff format described in FIG. 4B. Various types of pre-trained LLMs 112 can be utilized. In some implementations, the LLM 112 is trained to generate variants of a text input in a diff format. Other types of language models, including small language models, can also be utilized.

In the example prompt tuning process 300, an error-correction step 304 is implemented to correct for hallucinations output by the pre-trained LLM 112. The error-correction step 304 can be performed in various ways. In some implementations, the error-correction step 304 includes taking the LLM output and prompting the LLM 112 to specifically discover and address for errors in the diff format—i.e., ensure that the LLM output is correctly in the diff format described in the LLM prompt 302 for generating the prompt variants. In other implementations, a different LLM is utilized for the error-correction step 304.

The example prompt tuning process 300 further includes evaluating the prompt variants 206. Before the prompt variants 206 are evaluated for performance, they are converted to corresponding full-length prompt candidates 210. In the depicted example, the prompt variants 206 are converted to full-length prompts using post-processing logic 306. With the initial prompt 106 known, logic can be used to parse and apply the changes described in the prompt variants 206 to generate full-length prompt candidates 210. Generally, prompting an LLM to output many different variants of a large prompt involves a large number of output tokens, which can be a bottleneck for inference speed. By having the LLM 112 output variants in a diff format and then convert them to full-length prompts, the prompt tuning process 300 can optimize and refine prompts much faster.

The evaluations of the prompt candidates 210 can be performed in various ways. In the depicted example, the prompt candidates 210 are fed through a pre-trained LLM 112 to generate outputs 308 used to determined various objective metrics describing performance and/or quality of the prompt candidates 210. The pre-trained LLM for evaluating prompt candidates 210 and the pre-trained LLM for generating prompt variants 206 can be the same LLM or different LLMs. The outputs 308 are compared to ground-truth data 310 to determine respective evaluation results 212 based on the performance and/or quality of the prompt candidates 210. The ground-truth data 310 describes a desired output associated with the initial prompt 106, and the prompt-tuning process 300 attempts to refine the prompt such that it will result in a desired output.

The evaluation results 212 can be implemented in various ways. In some implementations, the scores 212 represent how well the prompt candidates 210 performed in accordance with one or more target metrics. Any type of target metric can be used. The evaluation results 212 can then be used to select a prompt candidate 208 from the list of prompt candidates 210. For example, the prompt candidate with the best evaluation result 212, which can indicate that its output was most similar to the ground-truth data 310, can be selected. The selected prompt candidate 208 can be output as a tuned prompt or it can be used in the generation of prompt variants in the next iteration. In the depicted example, the selected prompt candidate 208 is utilized in combination with the LLM prompt 302 for generating prompt variants to generate a new iteration of prompt variants.

For the next iteration of prompt tuning, the process 300 utilizes gradients 216 to guide the prompt variant generation process. To generate the gradients, reasons 214 for the evaluation results 212 are first determined. The reasons 214 for the evaluation results 212 can be provided as text-based feedback on the performance of the prompt candidates 210. In some implementations, the reasons 214 for the evaluation results 212 describe why the prompt candidates 210 did not perform ideally in accordance with one or more target metric. The reasons 214 for the evaluation results 212 can be provided in various ways. In some implementations, they are provided via user feedback. In other implementations, the errors of the LLM output are fed into a prompt that instructs an LLM to describe the problems that could have led to the errors.

The reasons 214 for the evaluation results 212 are then used to generate the gradients 216. The gradients 216 can be implemented as natural language gradients that can be used to generate new prompt variants. For example, the gradients 216 can be used in combination with the selected prompt candidate 208 and the LLM prompt 302 for generating prompt variants to generate a new iteration of prompt variants that attempt to address the issues corresponding to the gradients 216 and, by extension, the reasons 214 for the evaluation results 212 of non-selected prompt candidates. This recursive feedback loop can be performed to iteratively refine the initial prompt 106 for a predetermined number of iterations or until the evaluation results 212 satisfy a predetermined criterion. For example, if the prompt candidates 210 result in an output 308 that is similar enough to the provided ground-truth data 310, the selected prompt candidate 208 for that iteration may be selected as the final tuned prompt and can be outputted.

FIGS. 4A and 4B show generation of a text file in an example diff format. FIG. 4A depicts the line-by-line contents of an initial text file 400 and an edited text file 402. In the depicted example, the edited text 402 contains the same number of lines as the initial text file 400. As shown, lines three and four are deleted from the initial text 400, which moves up lines five and six to lines three and four in the edited text 402. Lines five and six in the edited text are added. Lines one, two, seven, and eight remain the same. For diff format output, lines one, two, seven, and eight do not need to be included as they can be derived from the initial text 400 and their lack of description in the diff output. This enables storage savings and, in the case of LLM output, lower output tokens and faster inference speed. Edited text with larger numbers of similar lines can provide more efficiency.

FIG. 4B shows a diff output 404 describing the modification of the initial text 400 into the edited text 402. The diff output 404 of FIG. 4B shows an example of a specific diff format. As described in the sections above, any type of diff format can be implemented in the processes and methods described herein. In the example diff format, the diff output 404 includes information describing the initial text 400 and the edited text 402. For example, the first two lines of the diff output 404 can include local pathing of the file locations of the initial text 400 and the edited text 402, respectively. In some implementations, the diff format only includes information regarding the initial text 400. The diff output 404 further includes information describing the location of changes to be made, followed by the changes themselves. In the depicted example, the diff output 404 describes a single chunk of changes to be applied.

Information describing the starting line and how many lines the first set of changes is to be applied is indicated by two at signs, followed by −l,s+l,s, where ‘−’ describes the initial text, ‘+’ describes the edited text, ‘l’ describes the starting line, and ‘s’ describes the number of lines to be changed. In some implementations, the diff format only includes information regarding the initial text 400. In the depicted example, the location at which changes are to be applied is indicated by “@@−3,4+3,4 @@.” This indicates that the changes start at line three of the initial text 400 and spans four lines, ending at line six inclusive. Accordingly, lines one, two, seven, and eight remain unchanged. The next section of information describes changes to be made, where content following ‘−’ indicates deletion and content following ‘+’ indicates addition. Content without either indicates no change. In the depicted example, the first two lines describe deletions to be made (corresponding to lines three and four of the initial text 400). The next two lines indicate no change (corresponding to lines five and six of the initial text 400). The last two lines describe additions to be made (corresponding to lines five and six of the edited text 402).

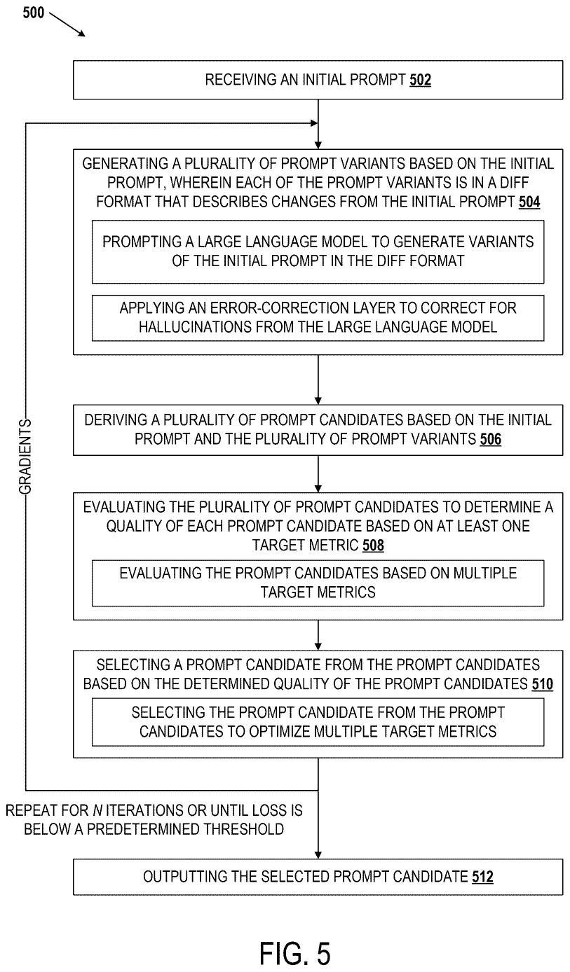

FIG. 5 shows a process flow diagram of an example prompt tuning method 500. At step 502, the method 500 includes receiving an initial prompt. The initial prompt can be structured in various ways. In some implementations, the initial prompt includes a task description and/or one or more canonical examples of the task. Although FIG. 5 depicts a method 500 for prompt tuning, such methods can be configured for any text-edit application. For example, the method 500 can be adapted to editing an email or any other text content. In such cases, the method 500 can include receiving an initial input text.

At step 504, the method 500 includes generating a plurality of prompt variants in a diff format. The plurality of prompt variants can be generated in various ways. In some implementations, the plurality of prompt variants is generated based on the initial prompt. The plurality of prompt variants can be in any type of diff format that describes changes based on an initial text and an edited text. In some implementations, the diff format is unidiff. In the example method 500 of FIG. 5, the initial text is the initial prompt, and the edited text is a prompt candidate that can be derived from the corresponding variant.

In some implementations, the prompt variants are generated by prompting a pre-trained LLM to generate variants of the initial prompt in a specified diff format. Various types of LLMs can be utilized. For example, the LLM can be pre-trained for generating prompt variants in a diff format. In some implementations, an error-correction layer is applied to correct for hallucinations from the LLM. For example, the LLM may output variants that are not in the correct diff format. As such, an error-correction step can be applied by prompting the LLM to determine if the variant is in the correct diff format and, if not, correct for the errors. The error-correction can be performed in various ways. In some implementations, the variant is fed back into the LLM, or another LLM, with a prompt tasking the LLM to determine and perform any necessary error correction.

At step 506, the method 500 includes deriving a plurality of prompt candidates. The plurality of prompt candidates can be derived in various ways. In some implementations, the plurality of prompt candidates is derived based on the initial prompt and the plurality of prompt variants. For example, post-processing logic can be applied to infer the changes necessary to generate the full-length prompt candidates from the prompt variants.

At step 508, the method 500 includes evaluating each of the plurality of prompt candidates to determine the quality of each prompt candidate. The plurality of prompt candidates can be evaluated in various ways. In some implementations, the prompt candidates are evaluated based on one or more target metrics that indicate the quality of the prompt. Examples of such include but are not limited to length of the prompt, relevancy of the prompt, LLM-based metrics that measure readability, LLM-based metrics that count the number of key points, etc. The results of the evaluation can be generated in various ways. In some implementations, ground-truth data describing a desired output corresponding to the initial prompt is provided. The outputs resulting from the prompt candidates can be compared to the ground-truth data to determine the quality of each prompt candidate. In some implementations, the evaluation results can be provided in the form of numerical values that indicate the quality of the prompt candidates. In some implementations, the plurality of the prompt candidates can be evaluated across multiple target metrics to determine the quality of the prompt candidates.

At step 510, the method 500 includes selecting a prompt candidate from the plurality of prompt candidates based on the determined quality of the prompt candidates. The prompt candidate can be selected in various ways. In some implementations, the prompt candidate is selected based on a single quality metric. In other implementations, the prompt candidate can be selected to optimize multiple target metrics. For example, the prompt candidate can be selected to maximize readability and relevancy of the prompt while minimizing its length.

At step 512, the method 500 includes outputting the selected prompt candidate. In some implementations, the selected prompt candidate is used to generate new prompt variants in a next iteration of the prompt tuning process. For example, steps 504-510 can be repeated for a number of iterations to refine the prompt further. In some implementations, a second plurality of prompt variants is generated based on the selected prompt candidate by prompting a pre-trained LLM to generate variants of the selected prompt candidate in a diff format using gradients. The gradients can be provided in various ways. Generally, the gradients are generated from evaluating a previous iteration of prompt variants, and the gradients provide information to guide the prompt variant generation process. In some implementations, the gradients are generated based on the reasons why at least one of the prompt candidates was not selected.

In some embodiments, the methods and processes described herein may be tied to a computing system of one or more computing devices. In particular, such methods and processes may be implemented as a computer-application program or service, an application-programming interface (API), a library, and/or other computer-program product.

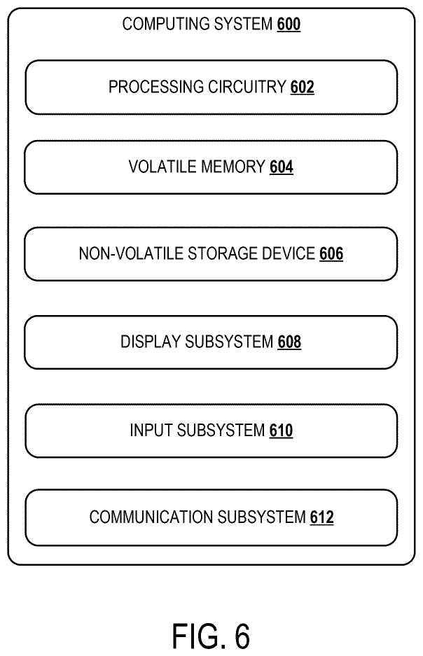

FIG. 6 schematically shows a non-limiting embodiment of a computing system 600 that can enact one or more of the methods and processes described above. Computing system 600 is shown in simplified form. Computing system 600 may embody the computing system 100 described above and illustrated in FIG. 1. Components of computing system 600 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

Processing circuitry 602 includes a logic processor that can be implemented with one or more physical devices configured to execute instructions. For example, the processing circuitry 602 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry 602 may include one or more physical processors configured to execute software instructions. Additionally or alternatively, the processing circuitry 602 may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry 602 optionally may be distributed among two or more separate devices, which may be remotely located and/or configured for coordinated processing. Aspects of the processing circuitry 602 may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the processing circuitry 602 to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional description of the subject matter of the present disclosure. One example includes a computing system for prompt tuning, the computing system comprising: processing circuitry and memory storing instructions that, during execution, causes the processing circuitry to: receive an initial prompt; generate a plurality of prompt variants based on the initial prompt, wherein each of the prompt variants is in a diff format that describes changes from the initial prompt; derive a plurality of prompt candidates based on the initial prompt and the plurality of prompt variants, wherein each of the prompt candidates is derived by applying the changes described in a respective prompt variant to the initial prompt; evaluate the plurality of prompt candidates to determine a quality of each prompt candidate based on at least one target metric; and select and output a prompt candidate from the plurality of prompt candidates based on the determined quality of the prompt candidates. In this example, additionally or alternatively, generating the plurality of prompt variants comprises prompting a large language model to generate prompt variants of the initial prompt in the diff format. In this example, additionally or alternatively, generating the plurality of prompt variants further comprises applying an error-correction layer to correct for non-diff format hallucinations from the large language model. In this example, additionally or alternatively, the at least one target metric comprises prompt readability. In this example, additionally or alternatively, the at least one target metric comprises prompt length. In this example, additionally or alternatively, the at least one target metric comprises prompt relevancy. In this example, additionally or alternatively, the instructions, during execution, further causes the processing circuitry to: generate a second plurality of prompt variants based on the selected prompt candidate; derive a second plurality of prompt candidates based on the selected prompt candidate and the second plurality of prompt variants; evaluate the second plurality of prompt candidates to determine the quality of each prompt candidate; and select and output a second prompt candidate from the second plurality of prompt candidates based on the determined quality of the prompt candidates. In this example, additionally or alternatively, generating the second plurality of prompt variants comprises prompting a large language model to generate prompt variants of the selected prompt candidate in the diff format using gradients generated based on reasons why at least one of the prompt candidates was not selected. In this example, additionally or alternatively, the plurality of prompt candidates is evaluated using a large language model and a ground truth label associated with the initial prompt. In this example, additionally or alternatively, the diff format comprises unidiff.

Another example includes a method for prompt tuning, the method comprising: receiving an initial prompt; prompting a large language model to generate variants of the initial prompt, wherein each of the variants is in a diff format that describes changes based on the initial prompt; deriving a plurality of prompt candidates based on the initial prompt and the plurality of variants, wherein each of the prompt candidates is derived by applying the changes described in a respective variant to the initial prompt; evaluating the plurality of prompt candidates to determine a quality of each prompt candidate based on at least one target metric; and selecting and outputting a prompt candidate from the plurality of prompt candidates based on the determined quality of the prompt candidates. In this example, additionally or alternatively, the method further comprises applying an error-correction layer to correct for non-diff format hallucinations from the large language model. In this example, additionally or alternatively, the at least one target metric comprises multiple quality metrics. In this example, additionally or alternatively, the method further comprises generating a second plurality of variants based on the selected prompt candidate and reasons why at least one of the prompt candidates was not selected. In this example, additionally or alternatively, the plurality of prompt candidates is evaluated using a large language model and a ground truth label associated with the initial prompt.

Another example includes a method for automatically editing text, the method comprising: receiving an initial text input; generating a plurality of diff text edits based on the initial text input, wherein each of the diff text edits is in a diff format describing changes based on the initial text input; deriving a plurality of text edits based on the initial text input and the plurality of diff text edits, wherein each of the text edits is derived by applying the changes described in a respective diff text edit to the initial text input; evaluating the plurality of text edits to determine a quality of each text edit based on at least one target metric; and selecting and outputting a text edit from the plurality of text edits based on the determined quality of the text edits. In this example, additionally or alternatively, generating the plurality of diff text edits comprises: prompting a large language model to generate variants of the initial text input in the diff format; and applying an error-correction layer to correct for non-diff format hallucinations from the large language model. In this example, additionally or alternatively, the at least one target metric comprises multiple quality metrics. In this example, additionally or alternatively, the method further comprises generating a second plurality of diff text edits based on the selected text edit and reasons why at least one of the text edits was not selected. In this example, additionally or alternatively, the method further comprises: deriving a second plurality of text edits based on the selected text edit and the second plurality of diff text edits; evaluating the second plurality of text edits to determine the quality of each text edit; and selecting and outputting a second text edit from the second plurality of text edits based on the determined quality of the text edits.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for prompt tuning, the computing system comprising:
processing circuitry and memory storing instructions that, during execution, causes the processing circuitry to:
receive an initial prompt;
generate a plurality of prompt variants based on the initial prompt, wherein each of the prompt variants is in a diff format that describes changes from the initial prompt;
derive a plurality of prompt candidates based on the initial prompt and the plurality of prompt variants, wherein each of the prompt candidates is derived by applying the changes described in a respective prompt variant to the initial prompt;
evaluate the plurality of prompt candidates to determine a quality of each prompt candidate based on at least one target metric; and
select and output a prompt candidate from the plurality of prompt candidates based on the determined quality of the prompt candidates.

2. The computing system of claim 1, wherein generating the plurality of prompt variants comprises prompting a large language model to generate prompt variants of the initial prompt in the diff format.

3. The computing system of claim 2, wherein generating the plurality of prompt variants further comprises applying an error-correction layer to correct for non-diff format hallucinations from the large language model.

4. The computing system of claim 1, wherein the at least one target metric comprises prompt readability.

5. The computing system of claim 1, wherein the at least one target metric comprises prompt length.

6. The computing system of claim 1, wherein the at least one target metric comprises prompt relevancy.

7. The computing system of claim 1, wherein the instructions, during execution, further causes the processing circuitry to:
generate a second plurality of prompt variants based on the selected prompt candidate;
derive a second plurality of prompt candidates based on the selected prompt candidate and the second plurality of prompt variants;
evaluate the second plurality of prompt candidates to determine the quality of each prompt candidate; and
select and output a second prompt candidate from the second plurality of prompt candidates based on the determined quality of the prompt candidates.

8. The computing system of claim 7, wherein generating the second plurality of prompt variants comprises prompting a large language model to generate prompt variants of the selected prompt candidate in the diff format using gradients generated based on reasons why at least one of the prompt candidates was not selected.

9. The computing system of claim 1, wherein the plurality of prompt candidates is evaluated using a large language model and a ground truth label associated with the initial prompt.

10. The computing system of claim 1, wherein the diff format comprises unidiff.

11. A method for prompt tuning, the method comprising:
receiving an initial prompt;
prompting a large language model to generate variants of the initial prompt, wherein each of the variants is in a diff format that describes changes based on the initial prompt;
deriving a plurality of prompt candidates based on the initial prompt and the plurality of variants, wherein each of the prompt candidates is derived by applying the changes described in a respective variant to the initial prompt;
evaluating the plurality of prompt candidates to determine a quality of each prompt candidate based on at least one target metric; and
selecting and outputting a prompt candidate from the plurality of prompt candidates based on the determined quality of the prompt candidates.

12. The method of claim 11, further comprising applying an error-correction layer to correct for non-diff format hallucinations from the large language model.

13. The method of claim 11, wherein the at least one target metric comprises multiple quality metrics.

14. The method of claim 11, further comprising:
generating a second plurality of variants based on the selected prompt candidate and reasons why at least one of the prompt candidates was not selected.

15. The method of claim 11, wherein the plurality of prompt candidates is evaluated using a large language model and a ground truth label associated with the initial prompt.

16. A method for automatically editing text, the method comprising:
receiving an initial text input;
generating a plurality of diff text edits based on the initial text input, wherein each of the diff text edits is in a diff format describing changes based on the initial text input;
deriving a plurality of text edits based on the initial text input and the plurality of diff text edits, wherein each of the text edits is derived by applying the changes described in a respective diff text edit to the initial text input;
evaluating the plurality of text edits to determine a quality of each text edit based on at least one target metric; and
selecting and outputting a text edit from the plurality of text edits based on the determined quality of the text edits.

17. The method of claim 16, wherein generating the plurality of diff text edits comprises:
prompting a large language model to generate variants of the initial text input in the diff format; and
applying an error-correction layer to correct for non-diff format hallucinations from the large language model.

18. The method of claim 16, wherein the at least one target metric comprises multiple quality metrics.

19. The method of claim 16, further comprising:
generating a second plurality of diff text edits based on the selected text edit and reasons why at least one of the text edits was not selected.

20. The method of claim 19, further comprising:
deriving a second plurality of text edits based on the selected text edit and the second plurality of diff text edits;
evaluating the second plurality of text edits to determine the quality of each text edit; and
selecting and outputting a second text edit from the second plurality of text edits based on the determined quality of the text edits.
